(19) United States
(12) Patent Application Publication
(10) Pub. No.: US 2014/0114806 A1
(43) Pub. Date: Apr. 24, 2014

(54) METHOD AND SYSTEM FOR REAL ESTATE SERVICES

(71) Applicant: Maximilian Meinhard, Santa Clarita, CA (US)

(72) Inventor: Maximilian Meinhard, Santa Clarita, CA (US)

(21) Appl. No.: 13/658,702

(22) Filed: Oct. 23, 2012

(51) Int. Cl. G06Q 30/00

(52) U.S. Cl. 705/26.41

(57) ABSTRACT

A method of brokering real estates between at least one potential real estate investor and at least one potential tenant performed on a system comprising an internet based platform accessible by at least one tenant and at least one investor with use of at least one user terminal wherein the method comprises the steps of entering and storing tenant data into a first database wherein tenant data comprises at least one parameter characterizing the tenant's desired real estate; entering investor data wherein said investor data comprises at least one parameter characterizing the investor's desired real estate; and analyzing said tenant data and said investor data and displaying matching data to bring a potential tenant and investor together for an investment project.

### TECHNICAL FIELD

The present disclosure refers to a method of brokering real estates between at least one potential real estate investor and at least one potential tenant. The present disclosure is also related to a system for operating the disclosed method.

### BACKGROUND OF THE PRESENT DISCLOSURE

The real estate market can be categorized into the rental market and into the purchase market. On the rental market homeowners offer their property for rental to a number of demanding tenants. On the purchase market homeowner offer their property for sale to a number of potential investors. At the moment, these markets are strictly separated from each other.

Rental or sale offers are usually published by newspaper advertisements or with help of respective web pages.

Many investors intend to purchase real estates as an investment property. Instead of moving into the bought real estate, these investors plan to rent their property out. However, any kind of investment project is usually associated with a few potential risks. For example, market values can continue dropping resulting in financial losses. Further, purchase costs and efforts for the investor can rapidly increase if the investor plans to purchase real estates abroad. Necessary travel costs can add up to a significant amount.

Another potential risk factor can be the tenant himself. The tenant may refuse to pay the negotiated rent. The resulting loss of rent could bring the investor into financial trouble. Moreover, many tenants destroy the property resulting in high costs for mandatory renovation work.

Due to the above mentioned substantial concerns only a fraction of potential investors actually execute their idea of investment.

On the other side, many tenants searching for a nice place to live face the following problems. A tenant cannot buy or does not like to buy real estate. Alternatively, the tenant has lost his previous house due to a personal or global financial crisis destroying his credit score. Also even if he might have recovered financially, he may not obtain a credit approval due to his negative credit score. Consequently, he needs to rent an appropriate real estate which limits him to only the small “rental” portion of the real estate market. He needs to live where he can rent and not where he wants to live.

### SUMMARY OF THE PRESENT DISCLOSURE

An embodiment of the present disclosure provides a method and a system for brokering real estates between at least one potential real estate investor and at least one potential tenant performed on an internet based platform accessible by at least one tenant and at least one investor. The internet platform offers an interface accessible and operable by at least one tenant and at least one investor, in particular accessible and operable over the World Wide Web. Investors and tenants can interact with the internet platform by means of personal computers, laptops, smartphones, etc.

A browser or a special application provides access to the internet platform.

The provided internet platform provides a way for the user, especially potential tenants, to enter and store their tenant data into a first database wherein tenant data comprises at least one parameter characterizing the tenant's desired real estate. Further, investors can enter investor data which comprises at least one parameter characterizing the investor's desired real estate. After having gathered all necessary information and data, the platform automatically analyzes the picked up data and looks for matching tenant and investor data. An appropriate matching result is provided to bring possible investors and tenants together for an investment project.

### BRIEF DESCRIPTION OF THE DRAWINGS

FIG. 1 is a block diagram illustrating an embodiment of the present disclosure.

FIGS. 2-5 show schematic views of the user input masks according to an embodiment of the present disclosure.

FIG. 6 is a flow diagram of a routine for storing user input.

FIG. 7 is another flow diagram of a routine for analyzing and displaying tenant or investor data.

### DETAILED DESCRIPTION OF THE PRESENT DISCLOSURE

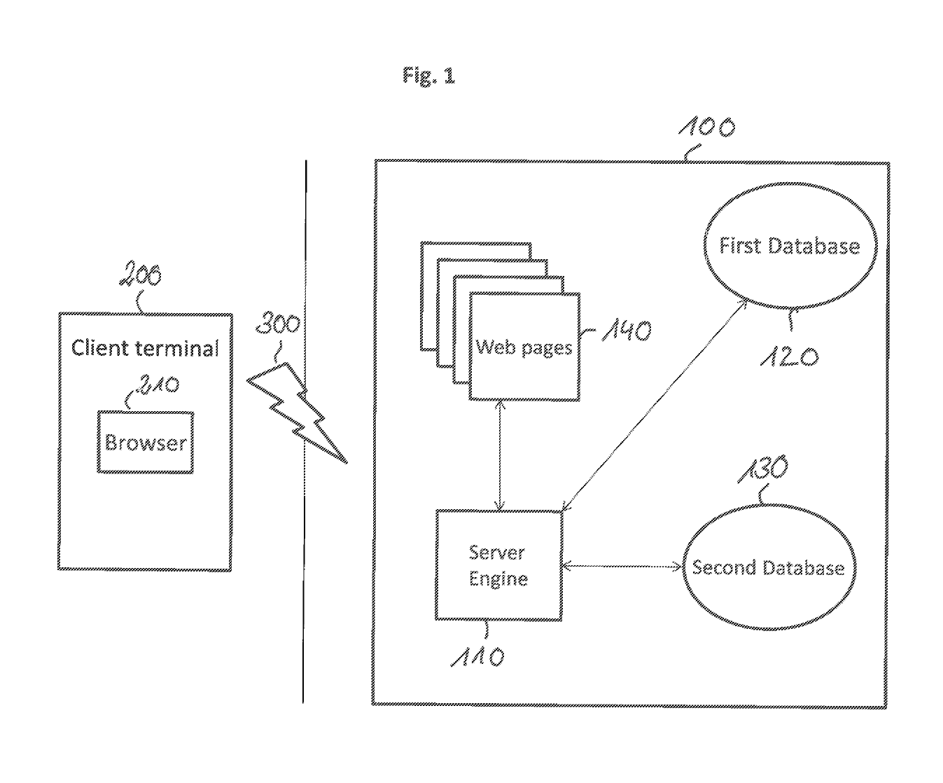

FIG. 1 is a block diagram illustrating an embodiment of the present disclosure. This embodiment supports brokering of real estates between at least one potential real estate investor and at least one potential tenant over the Internet using the World Wide Web. Both potential investors and potential tenants may provide information about themselves and about their desired real estates. The system will bring together potential tenants and investors which have similar preferences regarding their desired real estate. Both investors and tenants may pick up an appropriate partner for a real estate project from the result list provided by the inventive system. The tenant or investor or both of them will look for an appropriate real estate which will be purchased by the investor. The tenant will move into the purchased real estate.

An advantage for the tenant is that he might not only use the rental market for searching appropriate real estates. Instead, he can extend his search to the selling market of real estates. Therefore, the tenant might choose a place to live from the much bigger selling market rather than only from the rental market. A positive side effect is that landlords might look for the save of money rather than the maximum rental. This will lead to an overall cost reduction for the potential tenants.

On the other side, the inventive method for brokering real estates will bring a few advantages for the potential investors. An important question is the limitation of the financial risk when purchasing a real estate. By choosing a tenant before purchasing a house and by knowing the tenant, danger of loss of rental income or house damage can be sufficiently reduced. Further, the investor might reduce the expenses which arise during the search for an appropriate real estate. For example, travels to the target country where the potential real estate should be located can be reduced or eliminated during house searches as the cooperating tenant will take over the house search for the investor.

With respect to FIG. 1 the server system 100 includes a server engine 110, a first database 120, a second database 130 and various Web pages 140 which are accessible over the World Wide Web. The server engine 110 receives HTTP requests to access Web pages 140 identified by URLs and provides the Web pages 140 to the various client systems 200. The client terminal, server engine, etc., may include computer readable storage medium having instructions encoded therein for carrying out the various actions described hereinbelow. It should be appreciated that the user interface features described hereinbelow may be displayed via devices, such as monitors, smart phones, tablets, etc., and that the particular design, order of presentation, and/or layout can be particularly suited to the real estate brokering of the present application in such a way that the internet-based approaches is particularly advantageous, cost effective, manageable, and timely.

A HTTP request may be used to input tenant or investor data into respective input masks displayed by the Web pages 140 and to transmit the inserted data to the server system 100.

The first database 120 stores tenant profiles which contain several parameters characterizing the tenant's desired real estate. For example, at least one parameter may describe the exact desired home type, the minimum or maximum number of rooms, the minimum or maximum living space, the maximum or minimum land area, the year of construction, and the maximum payable rent.

Further, the tenant profiles may also include personal data as information about the tenant's name, the tenant's age, the tenant's credit score, the tenant's age, the tenant's income, the tenant's race, the tenant's religion, the tenant's gender, the tenant's political view, the tenant's family status.

The second database 130 stores investor profiles which contain several parameters characterizing the investor's desired real estate. For example, at least one parameter may describe the exact desired home type, the minimum or maximum number of rooms, the minimum or maximum living space, the maximum or minimum land area, the year of construction, and the minimum or maximum desired rent.

Further, the investor profiles may also include personal data as information about the investor's name, the investor's age, the investor's age, documents as evidence for a preliminary preapproval or a bank statement. By way of these documents the investor should prove that he can afford a real estate.

As a client terminal 200 each device which is connectable to the World Wide Web could be used. The client terminal 200 can access the Web pages 140 of the server system 100 via a browser 210 running as an application on the client terminal 200. The server and client terminals interact by exchanging information via communication link 300, which may include transmission over the Internet.

One skilled in the art would appreciate that the disclosed method of brokering real estates can be used in various environments other than the Internet. Also, various communication channels may be used such as local area networks, wide area networks, or point-to-point dial up connections. Also, a server system may comprise any combination of hardware or software that can administrate the required databases and perform the necessary method steps. A client terminal 200 may comprise any combination of hardware or software that can interact with the server system 100. These client terminals 200 may include television-based systems or various other consumer products through which interaction with the server system 100 is possible.

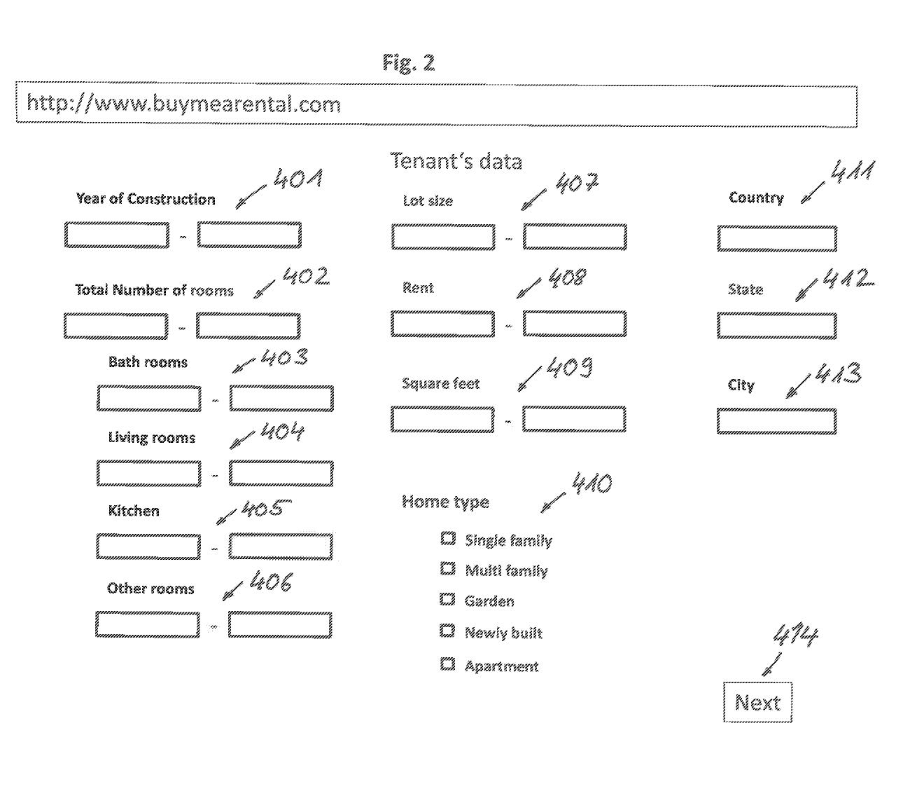

FIGS. 2, 3 and 4, 5 illustrate the data entry mechanism for the respective tenant or investor data over the Web pages 140 in a preferred embodiment. When the client terminal 200 starts an HTTP Request to the server system 100 an initial Web page 140 will be displayed at the client terminal 200. The user of the client terminal 200 may authenticate himself as a tenant or alternatively as a potential investor.

If the user is a potential tenant a first Web page 140 depicted in FIG. 2 will be displayed prompting the tenant to enter the respective information into the series of data entry fields. The Web page displays several entry masks for a few parameters of the tenant's data which are related to the desired real estate of the tenant. For example, entry field 401 asks for a desired time range in which the desired real estate has been constructed. The tenant may enter by way of the input interface of the client terminal a minimum and maximum construction year. By entering the same year in both fields the input will be limited to a specified year.

Further, a few entry fields for the number of rooms 402 exist which are divided into several subcategories as the number of bath rooms 403, number of living rooms 404, number of kitchens 405 and the number of other rooms 406. The tenant may enter a desired range or an absolute value for each room type.

Moreover, entry fields exist for the desired lot size 407, the minimum or maximum rent he is willing to pay 508 and the square feet of the living space 409. The tenant may enter a desired range or an absolute value.

With help of the entry fields 411, 412 and 413 the tenant can specify where the desired real estate should be located. The location may be limited to a certain country, state or city. Of course, further restriction to certain districts is conceivable.

At last, the Web page also displays a number of check boxes 410 for specifying the desired house type. As can be seen from the drawing the available categories are pre-defined and can be activated by a simple mouse click or a respective control command. Single or multiple choose may be permitted. The embodiment contains the categories single family house, multifamily house or an apartment, a house with garden, a newly built house or apartment. Of course, many other categories may be offered for activation.

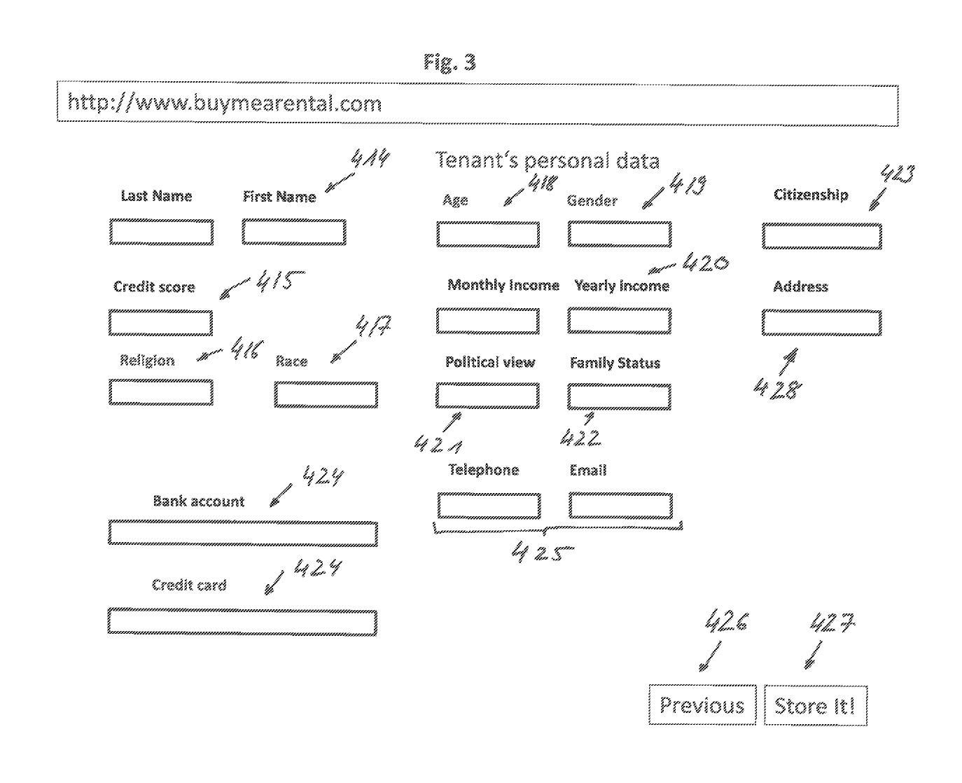

The user entry might be at least partly mandatory or at least partly voluntary. After entering the mandatory or voluntary information the button “next” 414 may be clicked and the user will be directed to the following Web page which is depicted by FIG. 3.

The shown Web page will prompt the tenant for entering his personal data. The shown entry fields offer the possibility to enter the tenant's name 414, the tenant's age 418, the tenant's credit score 415, the tenant's income, subdivided into the monthly and yearly income 420, the tenant's race 417, the tenant's religion 416, the tenant's gender 419, the tenant's political view 421, the tenant's citizenship 423 or the tenant's family status 422. Further, the tenant may also provide personal information about is current postal address 428 and contact information, i.e. email or telephone 425.

Since the inventive system may charge the tenant for the demanded service the tenants can enter his bank account or credit card data 424.

By clicking the “store it” button 427 the entered information of both Web pages will be transmitted to the server system 100 over the internet link 300. If the tenant needs to correct the inserted data, he could apply the “previous” button to reach the previous Web page according to FIG. 2.

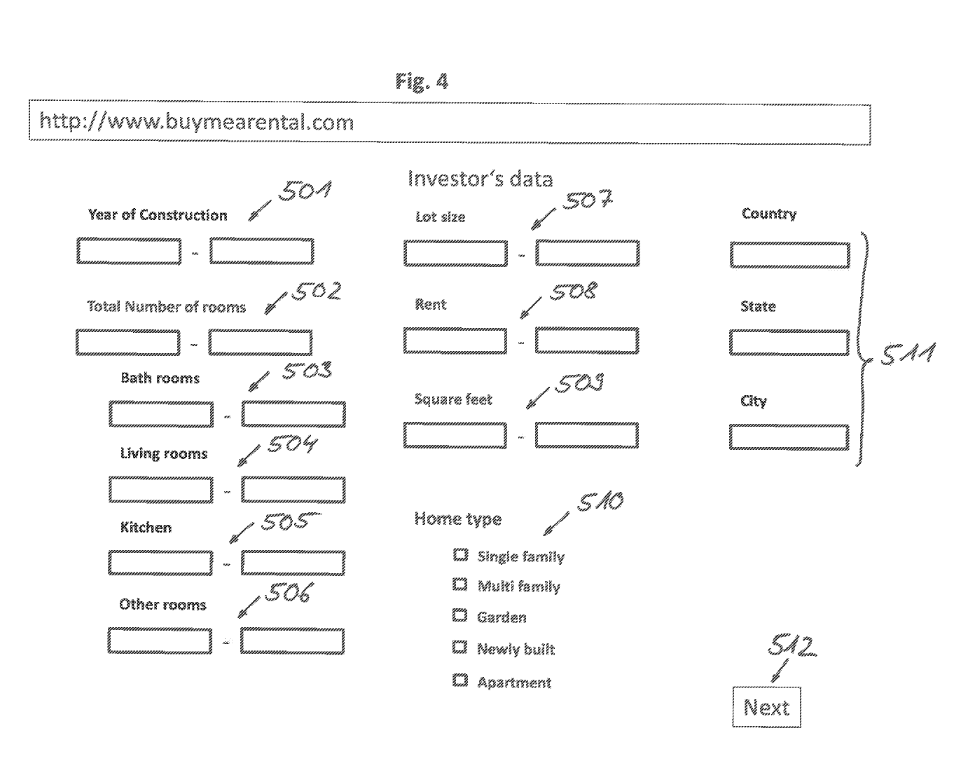

If the user is a potential investor a first Web page 140 depicted in FIG. 4 will be displayed prompting the investor to enter the respective information into the series of data entry fields. The Web page displays several entry masks for a few parameters of the investor's data which are related to the desired real estate of the investor. For example, entry field 501 asks for a desired time range in which the real estate has been constructed. The investor may enter by way of the terminal input interface a minimum and maximum construction year. By entering the same year in both fields the input will be limited to a specified year.

Further, several entry fields for the number of rooms 502 exist which are divided into several subcategories as the number of bath rooms 503, number of living rooms 504, number of kitchens 505 and the number of other rooms 506. The investor may enter a desired range or an absolute value.

Moreover, entry fields exist for the desired lot size 507, the minimum or maximum rent he is intending to demand from a potential tenant 508 and the square feet of the living space 509. The investor may enter a desired range or an absolute value.

With help of the entry fields 511, 512 and 513 the investor can specify where the desired real estate should be located. The location may be limited to a certain country, state or city. Of course, further restriction to certain districts is conceivable.

At last, the Web page also displays a number of check boxes 510 for specifying the desired house type. As can be seen from the drawing the available categories are pre-defined and can be activated by a simple mouse click or a respective control command. Single or multiple choose may be permitted. The embodiment contains the categories single family house, multifamily house or an apartment, a house with garden, a newly built house or apartment. Of course, many other categories may be offered for activation.

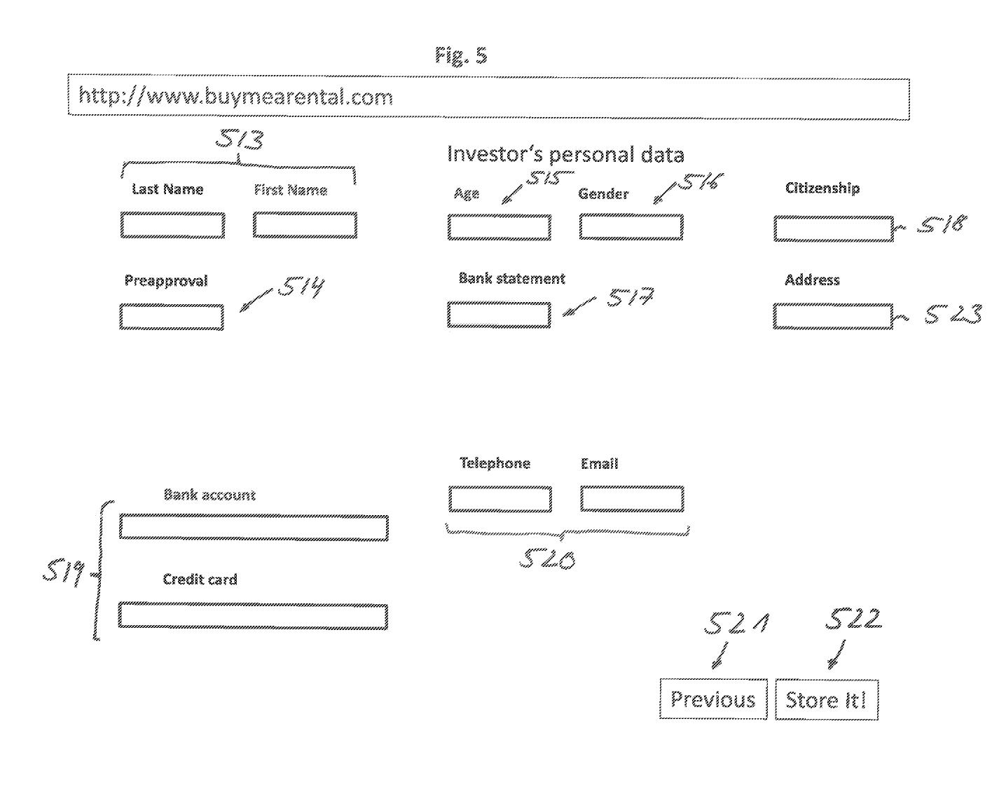

The user entry might be at least partly mandatory or at least partly voluntary. After entering the mandatory or voluntary information the button “next” 512 may be clicked and the user will be directed to the following Web page which is depicted by FIG. 5.

The shown Web page will prompt the investor for entering his personal data. The shown entry fields offer the possibility to enter the investor's name 513, the investor's age 516, a preapproval 514 or a bank statement 517, the investor's gender 516 or the investor's citizenship 518. Further, the inventor may also provide personal information about his current postal address 523 and contact information, i.e. email or telephone 520. The entry fields 514 and 517 may provide a possibility to upload respective documents which prove the preapproval of the planned investment.

Since the inventive system may charge the investor for the demanded service the investor can enter his bank account or credit card data 519.

By clicking the “store it” button 522 the entered information of both Web pages will be transmitted to the server system 100 over the internet link 300. If the investor needs to correct the inserted data, he could apply the “previous” button 521 to reach the previous Web page according to FIG. 4.

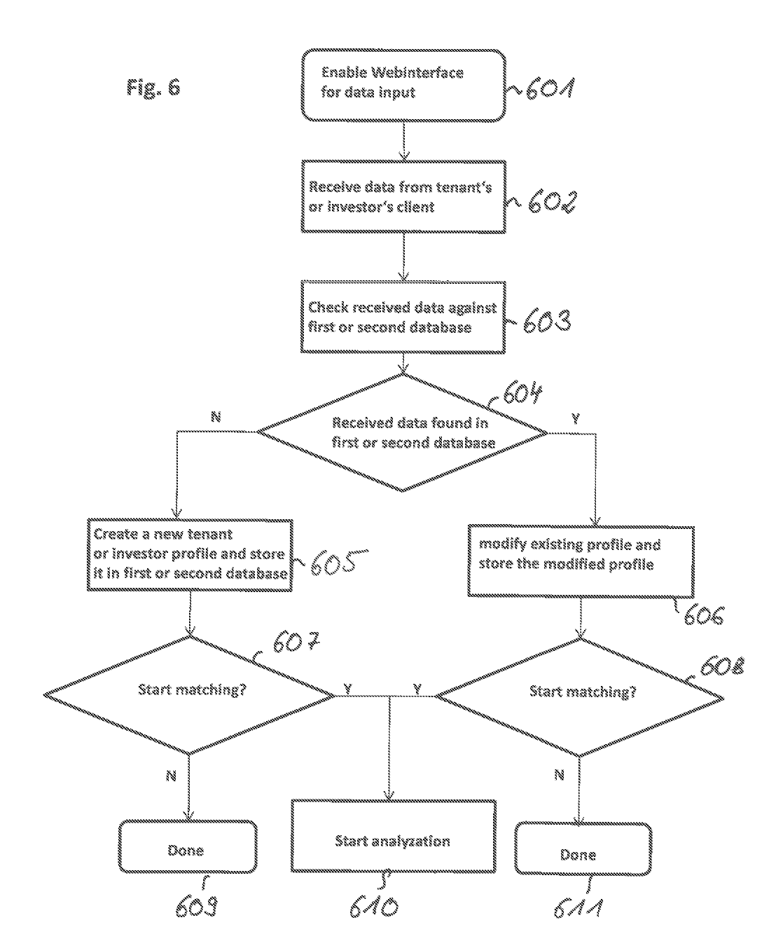

FIG. 6 is a flow diagram of a routine that enables the method according to the disclosure and which is performed by the server engine 110 of the server system 100. To enable the inventive method at the server system in step 601 a user, e.g. a potential tenant or investor, needs to point the browser 210 of his client terminal 200 to the corresponding URL of the server system 100, in particular the URL of the initial index Web page 140. After the initial HTTP request the index Web page is displayed at the customer's browser 210. Further, the customer has to identify himself as a potential tenant or investor.

Afterwards, the potential tenant or investor is requested to providing specified tenant or investor information to the server system 100. The server system 100 can obtain this information by prompting the customer using the Web pages according to FIGS. 2 to 5. After the customer has at least partly filled out the aforementioned entry fields and applied the “Store it!” button 512, 522 the data is transmitted over the Internet 300 and received by the server system 100 in step 602.

In step 603 the server engine 110 checks the received data and compares it to the data stored in the first and second database 120, 130. If the customer has identified himself as a tenant before, the received data will be compared to the content of the first database 120. If the customer is an investor the received data will be compared to the content of the second database 130.

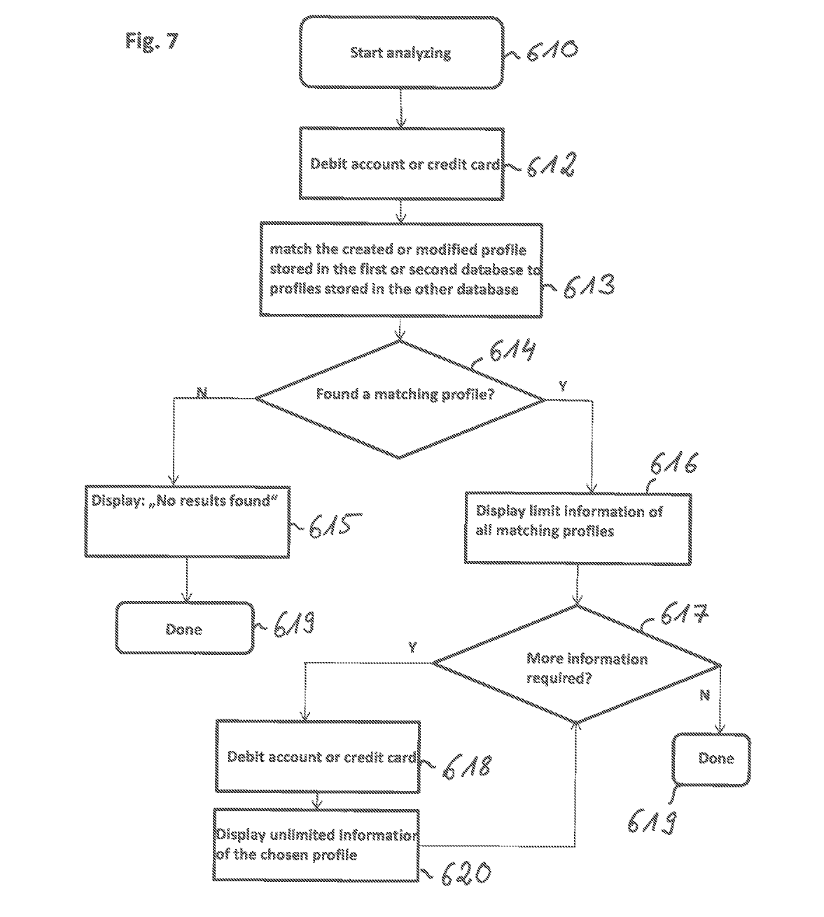

The user data is stored and managed by use of profiles. Therefore, server engine 110 will check the received user data against tenant or investor profiles stored in the first and second database 120, 130. The individual profiles are marked by the tenant's or investor's name or any other identification information. In step 604 the engine 110 checks if any profile already exists which matches to the received data. In case of a positive match the routine will jump to step 606 for synchronizing the data stored in a profile at the respective database by overwriting the profile data with the newly received data. Afterwards, the routine checks in step 608 whether the customer requests an analyzing process. If the user sends a command requesting the system to find appropriate project partners, the routing will step over to block 610 which will be later on discussed with respect to FIG. 7. Otherwise, the routine is done 611.

In case of no matching profile in step 604 the routine will go to block 605 to create a new profile on the bases of the received data. If the customer is a tenant the created profile will be stored into database 120. If the received data belongs to a potential investor the newly created profile will be maintained in database 130. Afterwards, the routine checks in step 607 whether the customer requests an analyzing process. If the user sends a command requesting the system 100 to find appropriate project partners, the routine steps over to block 610 which will be discussed later on with respect to FIG. 7. Otherwise, the routine is done 619.

FIG. 7 is a flow diagram of a routine performed by the server engine 110 on an explicit customer demand. If the routine of FIG. 6 has reached block 610 the routine of FIG. 7 will be executed.

The service offered by the system 100 is not free of charge. In the shown embodiment the step of analyzing tenant and investor profiles will be charged. For example, the requesting customer has to acquit the incurring amount. Therefore, the routine will automatically debit a bank account or credit card according to the information 424, 519 of the respective customer profiles in block 612. Thereafter, the routine will jump to block 613 for starting the analyzing process. The profile of the requesting customer will be compared to profiles stored in the other database. For example, if the customer is a tenant his profile will be compared to all investor profiles maintained in the second database 130. If the customer is an investor the systems scans the first database 120 for appropriated tenant profiles.

The criteria for matching profiles are defined on the bases of at least one parameter contained in the tenant or investor data (block 614). That is to say, that at least one parameter of the customer's profile according to the information given in FIG. 2 or 4 should comply with a corresponding parameter of a profile stored in a database. For example, mandatory examined parameters are the real estate location, the payable or desired rent, the type of house, etc.

If a certain number of parameters of the examined profiles comply with each other the system will display a positive match of at least two profiles (block 615). The certain number may be manually modified by the customer or automatically by the system 100 in order to limit or increase the number of the displayed positive matching profile results. If no positive matching profiles could be found the system will display a respective message (block 616) informing the customer that no appropriate project partner could be determined. The routine will jump to an initial state 619.

In case of at least one positive matching profile in block 614 the routine will display all eligible profiles in block 616. However, only a limited scope of information contain in the matching profiles will be displayed. In particular, personal data as depicted in FIGS. 3 and 5 will be limited to a predefined presetting of the information owner.

If the customer desires receiving the total set of personal information of a chosen profile his bank account or credit card will be debited with the incurring charge fee (block 618). In case of a successful payment transaction the system will provide the complete profile data to the requesting customer in block 620. Afterwards, the routine is redirected to block 617. The customer could choose another profile and request additional information by re-executing the aforementioned steps of blocks 618, 620. Otherwise the routine will go to its initial state 619.

Although the present disclosure has been described in terms of a single embodiment, it is not intended that the present disclosure is limited to this embodiment. Modification within the spirit of the present disclosure will be apparent to those skilled in the art. For example, the server system could also charge every new database entry of a tenant or investor. The block 612 according to FIG. 7 might be incorporated into the flow diagram of FIG. 6, for example right before the execution of block 605.

Further, FIGS. 2 to 5 describe a possible design of a Web page 140. However, modification relating to the homepage design or the number of parameters or personal data can be increased or decreased. It might make sense to include a separate process for the modification of stored profiles. The customer might receive his profile and make modifications to one or more entries.

1. A method of brokering real estates between at least one potential real estate investor and at least one potential tenant performed on a system comprising an internet based platform accessible by at least one tenant and at least one investor with use of at least one user terminal wherein the method comprises the steps of:
entering and storing tenant data into a first database wherein tenant data comprises at least one parameter characterizing the tenant's desired real estate;
entering investor data wherein said investor data comprises at least one parameter characterizing the investor's desired real estate; and
analyzing said tenant data and said investor data and displaying matching data to bring a potential tenant and investor together for an investment project.

2. The method according to claim 1, wherein said at least one parameter characterizing the desired real estate is related to at least one of the group of home type, number of rooms, living space, land area, year of construction, and desired or payable rent.

3. The method according to claim 1, wherein investor data is stored into a second database and the step of analyzing is performed by a comparison of the first and second databases.

4. The method according to claim 1, wherein the tenant data includes personal data containing at least information about one or more of the tenant's name, the tenant's age, the tenant's credit score, the tenant's age, the tenant's income, the tenant's race, the tenant's religion, the tenant's gender, the tenant's political view, and the tenant's family status.

5. The method according to claim 1, wherein said investor data includes personal data containing at least information about one or more of the investor's name, the investor's age, the investor's credit score, the investor's income, the investor's race, the investor's religion, the investor's gender, the investor's political view, the investor's family status, and the investor's preapproval or bank statement.

6. The method according to claim 4, wherein the personal data is at least partly voluntary.

7. The method according to claim 1, wherein the step of analyzing matches the tenant and investor data by taking into account the at least one parameter characterizing the desired real estate.

8. The method according to claim 1, wherein the tenant and/or the investor can create or modify personal profiles for organizing their personal data and their parameters.

9. The method according to claim 1, wherein limited investor and/or tenant data is published to the investor and/or tenant in case of a matching result of the tenant's and investor's data.

10. The method according to claim 9, wherein a scope of the published tenant or investor data or information is adjustable or limitable by an information owner or a system administrator.

11. The method according to claim 1, wherein extended tenant data is provided after a respective request for unlimited access.

12. The method according to claim 1, wherein at least one investor can search the first database for a potential tenant by one or more certain search parameters.

13. The method according to claim 1, wherein the platform charges the tenant for a database entry into the first database or for a modification of the data stored in the first database.

14. The method according to claim 1, wherein the investor is charged for a request for unlimited information about data of at least one tenant stored in the first database.

15. A server system for brokering real estates between at least one potential real estate investor and at least one potential tenant which is accessible by at least one tenant and at least one buyer by use of a client terminal, the system comprising:
a first database having electronic storage and an input for receiving and storing tenant data into the first database, wherein tenant data comprises at least one parameter characterizing the tenant's desired real estate;
a second database having electronic storage and an input for receiving and storing investor data into the second database, wherein said investor data comprises at least one parameter characterizing the investor's desired real estate; and
a processor for analyzing the first and second database and sending display data for displaying matching tenant and investor data to bring a potential tenant and investor together for an investment.

16. The system according to claim 15, wherein said at least one parameter characterizing the desired real estate is related to one or more of a home type, a number of rooms, a living space, a land area, and a year of construction.

17. The system according to claim 15, wherein the system is adapted for creation or modification of investor or tenant profiles managing their personal data and their parameters.

18. The system according to claim 15, wherein the system is adapted to adjust or limit a scope of published investor or tenant data, wherein the adjustment or limitation is under control of a respective data owner or a system administrator.

19. The system according to claim 15, wherein the platform is adapted to charge the investor or tenant for a database entry or for the process of analyzing and matching or for displaying at least one successful matching result.

20. A method of brokering real estates between at least one potential real estate investor and at least one potential tenant performed on a system comprising an internet based platform accessible by at least one tenant and at least one investor with use of at least one user terminal wherein the method comprises the steps of:
entering and storing tenant data into a first database wherein tenant data comprises at least one parameter characterizing the tenant's desired real estate, wherein the tenant data further comprises personal information about the tenant regarding his current credit score;
entering a search string by a potential investor or a proprietor for searching the first database for a potential tenant by one or more certain search parameters;
analyzing and matching the search string to at least one tenant data of the database; and
displaying said tenant data to bring together the investor or the proprietor and the at least one tenant for an investment or rental project.
